(19) United States
(12) Patent Application Publication
(10) Pub. No.: US 2024/0101803 A1
(43) Pub. Date: Mar. 28, 2024

(54) THERMOPLASTIC ELASTOMERIC COMPOSITION FOR VEHICLE MOUNTS WITH IMPROVED SURFACE ENERGY AND COMPRESSION SET, AND MOLDED ARTICLE INCLUDING THE SAME

(71) Applicants: Hyundai Motor Company, Seoul (KR); Kia Corporation, Seoul (KR); HWASEUNG Material Co., Ltd., Yangsan (KR)

(72) Inventors: Sang Hyun Lee, Jeju (KR); Young Chul Shin, Suwon (KR); Ji Hye Park, Goyang (KR); Ki Hyun Cho, Hwaseong (KR); Han Sang Lee, Hwaseong (KR); Kyoung Min Hong, Yangsan (KR); Ki Jae Kim, Yangsan (KR)

(21) Appl. No.: 18/142,310

(22) Filed: May 2, 2023

(30) Foreign Application Priority Data
Sep. 23, 2022 (KR) 10-2022-0120499

(51) Int. Cl. C08L 23/16; C08K 5/54; C08L 23/08; C08L 23/12; C08L 53/02

(52) U.S. Cl. CPC C08L 23/16; C08K 5/54; C08L 23/08; C08L 23/12; C08L 53/02; C08L 2203/30; C08L 2205/025; C08L 2205/03; C08L 2207/04

(57) ABSTRACT

Disclosed are a thermoplastic elastomeric composition for vehicle mounts which has improved surface energy and compression set while solving reduction in wear strength, by blending EPDM rubber, polypropylene, silicon, and poly(styrene-ethylene-butadiene-styrene) (SEBS) in appropriate amounts, and a molded article including the same.

### CROSS-REFERENCE TO RELATED APPLICATION

This application claims under 35 U.S.C. § 119(a) the benefit of priority to Korean Patent Application No. 10-2022-0120499 filed on Sep. 23, 2022, the entire contents of which are incorporated herein by reference.

### TECHNICAL FIELD

The present disclosure relates to a thermoplastic elastomeric composition and a molded article including the same. The thermoplastic elastomeric composition for vehicle mounts may have improved surface energy and compression set while solving reduction in wear strength, by including EPDM rubber, polypropylene, silicon, and poly(styrene-ethylene-butadiene-styrene) (SEBS).

### BACKGROUND

An EPDM/PP thermoplastic elastomer is manufactured by blending a thermosetting elastomer, i.e., EPDM, and thermoplastic, i.e., PP, and more particularly, is manufactured through dynamic vulcanization in which EPDM is vulcanized during such a blending process.

The EPDM/PP thermoplastic elastomer can be molded again and be reusable, in contrast to the conventional thermosetting elastomer, and is thus eco-friendly, and has a low density compared to EPDM, thereby being used as an eco-friendly and lightweight material in the automobile industry. However, when the EPDM/PP thermoplastic elastomer is applied to a tail guide bumper of a vehicle, a fine annoying noise may occur during driving of the vehicle with a high bonding force between attachments due to the low surface energy of the EPDM/PP thermoplastic elastomer. When the bonding force is reduced, the compression set of the EPDM/PP thermoplastic elastomer is increased, and thus exerts a negative influence on the shock mitigation performance of the tail gate bumper. Further, when hardness of the EPDM/PP thermoplastic elastomer is reduced as a method of lowering the bonding force, wear strength of an EPDM/PP thermoplastic elastomer product is reduced.

Therefore, development of a thermoplastic elastomer which improves both surface energy and compression set and solves reduction in wear strength has been continued

The above information disclosed in this Background section is only for enhancement of understanding of the background of the invention and therefore it may contain information that does not form the prior art that is already known in this country to a person of ordinary skill in the art.

### SUMMARY

In preferred aspects, the present disclosure provides a thermoplastic elastomeric composition for vehicle mounts, which has improved surface energy and compression set while solving reduction in wear strength of a product, and a molded article including the same.

In one aspect, the present disclosure provides a thermoplastic elastomeric composition including an amount of about 80 parts by weight of ethylene propylene diene monomer (EPDM) rubber, an amount of about 30 to 70 parts by weight of polypropylene (PP), an amount of about 2 to 15 parts by weight of silicon, and an amount of about 20 to 40 parts by weight of poly(styrene-ethylene-butadiene-styrene) (SEBS).

The term “thermoplastic elastomer” as used herein refers to a rubber or rubber-like olefin resin including or formed of long chainlike molecules that are capable of recovering their original shape after being stretched. Exemplary elastomer or rubber may include natural rubber, neoprene rubber, buna-s and buna-n rubber, which are modified or unmodified alkyl or aliphatic chains having carbon backbones linked together by single (C—C) or double (C═C) bonds. In certain embodiments, the thermoplastic elastomer is a blend of one or more rubbers or olefin resins, optionally including filler or modifying agent (e.g., silicon).

The EPDM rubber may include, based on the total weight thereof, an amount of about 50 to 70 wt % of polyethylene (PE), an amount of about 5 to 10 wt % of ethylidene norbornene (ENB), and a balance of polypropylene (PP).

The thermoplastic elastomeric composition may further include additives, and the additives may include a crosslinking agent, a crosslinking assistant, a surface modifier, a lubricant, an antioxidant, a crosslinking accelerator, a filler, a UV stabilizer, and a plasticizer.

Preferably, the additives may include an amount of about 0.1 to 0.9 parts by weight of the crosslinking agent, an amount of about 0.1 to 0.5 parts by weight of the crosslinking assistant, an amount of about 1 to 3 parts by weight of the surface modifier, an amount of about 1 to 3 parts by weight of the lubricant, an amount of about 0.1 to 0.5 parts by weight of the antioxidant, an amount of about 1 to 3 parts by weight of the crosslinking accelerator, an amount of about 10 to 30 parts by weight of the filler, an amount of about 1 to 5 parts by weight of the UV stabilizer, and an amount of about 60 to 80 parts by weight of the plasticizer, per 80 parts by weight of the EPDM rubber.

The thermoplastic elastomeric composition may have surface energy of about 20 to 35 mN/m.

The thermoplastic elastomeric composition may have a water contact angle of about 100 to 120° with a surface of a tail gate bumper, and a diiodo methane contact angle of about 60 to 80° with the surface of the tail gate bumper.

In another aspect, the present disclosure provides a molded article for vehicle mounts, including the thermoplastic elastomeric composition as described herein.

The molded article may have tensile strength of about 5 to 10 MPa and elongation of about 400 to 600%, measured based on ISO 37.

The molded article may have a compression set of about 35 to 45%, measured based on ISO 815.

In an aspect, also provided is a vehicle including the molded article as described herein.

Other aspects of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIGS. 1A and 1B are photographs showing results of opening and closing durability evaluation of tail gates of vehicles using thermoplastic elastomeric compositions according to an exemplary embodiment of the present disclosure and a comparative example; and

FIG. 2 is a table representing surface energy values of the surfaces of tail gate bumpers depending on silicon contents in thermoplastic elastomeric compositions.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes, will be determined in part by the particular intended application and use environment.

In the figures, reference numbers refer to the same or equivalent parts of the present invention throughout the several figures of the drawings.

### DETAILED DESCRIPTION

The above-described objects, other objects, advantages and features of the present invention will become apparent from the descriptions of embodiments given hereinbelow with reference to the accompanying drawings. However, the present invention is not limited to the embodiments disclosed herein and may be implemented in various different forms. The embodiments are provided to make the description of the present invention thorough and to fully convey the scope of the present invention to those skilled in the art.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

In the following description of the embodiments, it will be understood that, when the range of a variable is stated, the variable includes all values within the stated range including stated end points of the range. For example, it will be understood that a range of “5 to 10” includes not only values of 5, 6, 7, 8, 9 and 10 but also arbitrary subranges, such as a subrange of 6 to 10, a subrange of 7 to 10, a subrange of 6 to 9, and a subrange of 7 to 9, and arbitrary values between integers which are valid within the scope of the stated range, such as 5.5, 6.5, 7.5, 5.5 to 8.5, and 6.5 to 9. Further, for example, it will be understood that a range of “10% to 30%” includes not only all integers including values of 10%, 11%, 12%, 13%, . . . 30% but also arbitrary subranges, such as a subrange of 10% to 15%, a subrange of 12% to 18%, and a subrange of 20% to 30%, and arbitrary values between integers which are valid within the scope of the stated range, such as 10.5%, 15.5%, and 25.5%.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

A thermoplastic elastomeric composition may include 80 parts by weight of ethylene propylene diene monomer (EPDM) rubber, an amount of about 30 to 70 parts by weight of polypropylene (PP), an amount of about 2 to 15 parts by weight of silicon, and an amount of about to 40 parts by weight of poly(styrene-ethylene-butadiene-styrene) (SEBS). Particularly, the thermoplastic elastomeric composition may further include, as additives, an amount of about 0.1 to 0.9 parts by weight of a crosslinking agent, an amount of about 0.1 to 0.5 parts by weight of a crosslinking assistant, an amount of about 1 to 3 parts by weight of a surface modifier, an amount of about 1 to 3 parts by weight of a lubricant, an amount of about 0.1 to 0.5 parts by weight of an antioxidant, an amount of about 1 to 3 parts by weight of a crosslinking accelerator, an amount of about 10 to 30 parts by weight of a filler, an amount of about 1 to 5 parts by weight of a UV stabilizer, and 6 an amount of about 0 to 80 parts by weight of a plasticizer, per 80 parts by weight of the EPDM rubber.

It will be made clear in advance that the contents of the respective components of the thermoplastic elastomeric composition, which will be described below, are set based on 80 parts by weight of the EPDM rubber. If such a criterion is changed, the changed criterion will be specified, and thus, it will be apparent to those skilled in the art that based on which component the contents of the respective components are described.

The respective components of the thermoplastic elastomeric composition according to the present invention will be described in more detail as follows.

(A) Ethylene Propylene Diene Monomer (EPDM) Rubber

The thermoplastic elastomeric composition may include 80 parts by weight of the EPDM rubber.

The EPDM rubber may include an amount of about 50 to 70 wt % of polyethylene (PE), an amount of about 5 to 10 wt % of ethylidene norbornene (ENB), and a balance of polypropylene (PP) based on the total weight of the EPDM rubber. The EPDM may include a terpolymer which results from copolymerization of ethylene, propylene, and diene. The propylene may be included from the balance of polypropylene (PP) included in the EPDM rubber, and polypropylene (PP) included in the EPDM rubber differs from polypropylene (PP) in an amount of about 30 to 70 parts by weight included in the thermoplastic elastomeric composition, per 80 parts by weight of the EPDM rubber, which will be described below.

When the content of polyethylene (PE) is less than about 50 wt % based on the total weight of the EPDM rubber, the tensile strength of the thermoplastic elastomeric composition may be reduced, and thus, the physical properties of thermoplastic elastomeric composition may be deteriorated. On the other hand, when the content of polyethylene (PE) is greater than about 70 wt % based on the total weight of the EPDM rubber, the crystallinity of the thermoplastic elastomeric composition may be increased, and thus the compression set of the thermoplastic elastomeric composition may be reduced.

Further, the EPDM rubber may include an amount of about 5 to 10 wt % of ethylidene norbornene (ENB) based on the total weight of the EPDM rubber. When the content of ethylidene norbornene (ENB) is less than about 5 wt %, a problem may occur during extrusion or injection molding. On the other hand, when the content of ethylidene norbornene (ENB) is greater than about 10 wt %, the hardness and strength of a product may be increased, and thus, difficulty in cutting during extrusion or injection molding may arise. The above amount of ethylidene norbornene (ENB) included in the EPDM rubber reduces the particle size of the EPDM rubber and improves dispersibility of particles of the EPDM rubber, and thus increases friction loss at the interfaces between the particles of the EPDM rubber and particles of polypropylene so as to improve elasticity and permanent deformability of a matrix resin and to increase damping characteristics thereof.

(B) Polypropylene (PP)

The thermoplastic elastomeric composition may include an amount of about 30 to 70 parts by weight of polypropylene (PP), per 80 parts by weight of the EPDM rubber. When the content of polypropylene (PP) is less than about 30 parts by weight, the hardness of the thermoplastic elastomeric composition may be reduced, and thus, wear strength of the thermoplastic elastomeric composition may be reduced. On the other hand, when the content of polypropylene (PP) is greater than about 70 parts by weight, the crystallinity of the thermoplastic elastomeric composition may be increased, and thus the compression set of the thermoplastic elastomeric composition may be reduced.

Such polypropylene (PP) and the EPDM rubber may form the matrix resin which is a basic material of the thermoplastic elastomeric composition of the present invention.

(C) Silicon

The thermoplastic elastomeric composition may include an amount of about 2 to 15 parts by weight of silicon, per 80 parts by weight of the EPDM rubber. When the content of silicon is less than about 2 parts by weight, a surface modification effect is poor, and, when the content of silicon is greater than about 15 parts by weight, the compression set of the thermoplastic elastomeric composition is reduced or defects occur during injection molding due to incompatibility between the EPDM rubber and silicon.

(D) Poly(styrene-ethylene-butadiene-styrene) (SEBS)

Poly(styrene-ethylene-butadiene-styrene) (SEBS) has compatibility with the matrix resin including the EPDM rubber and polypropylene (PP) in the thermoplastic elastomeric composition, and simultaneously improves the wear strength of the product.

The thermoplastic elastomeric composition may include an amount of about 20 to 40 parts by weight of poly(styrene-ethylene-butadiene-styrene) (SEBS), per 80 parts by weight of the EPDM rubber. When the content of poly(styrene-ethylene-butadiene-styrene) (SEBS) deviates from the above range, it is difficult to implement the wear strength of the product in the present invention.

(E) Additives

The additives serve to provide various functions to the thermoplastic elastomeric composition, and the thermoplastic elastomeric composition according to the present invention may further include the additives. The additives may include well-known materials within a range that does not impede the effects of the present invention, without being limited to a specific material.

The additives may include one or more selected from the group consisting of a crosslinking agent, a crosslinking assistant, a surface modifier, a lubricant, an antioxidant, a crosslinking accelerator, a filler, a UV stabilizer, and a plasticizer.

The contents of the respective additives are not limited to specific values. The thermoplastic elastomeric composition may include, as the additives, an amount of about 0.1 to 0.9 parts by weight of the crosslinking agent, an amount of about 0.1 to 0.5 parts by weight of the crosslinking assistant, an amount of about 1 to 3 parts by weight of the surface modifier, an amount of about 1 to 3 parts by weight of the lubricant, an amount of about 0.1 to 0.5 parts by weight of the antioxidant, an amount of about 1 to 3 parts by weight of the crosslinking accelerator, an amount of about 10 to 30 parts by weight of the filler, an amount of about 1 to 5 parts by weight of the UV stabilizer, and an amount of about 60 to 80 parts by weight of the plasticizer, per 80 parts by weight of the EPDM rubber.

Further, the present invention relates to a molded article for vehicle mounts including the thermoplastic elastomeric composition.

The molded article may be acquired by performing molding using the thermoplastic elastomeric composition through a method, such as extrusion molding, injection molding, compression molding, foam injection molding, low pressure foam injection molding, gas compression molding, etc.

The molded article may be employed as a molded article in fields in which not only surface energy and compression set but also wear strength are considered as important, without being limited to a specific field. For example, the molded article may be applied to parts including vehicle parts, machine parts, electrical and electronic parts, office equipment such as computers, and sundries.

The molded article may have tensile strength of about 5 to 10 MPa and elongation of about 400 to 600%, which are measured based on ISO 37.

The molded article may have a compression set of about 35 to 45%, which is measured based on ISO 815.

### EXAMPLE

Hereinafter, the present invention will be described in more detail through the following examples. The following examples serve merely to exemplarily describe the present invention, and are not intended to limit the scope of the invention.

### Examples 1 and 2, and Comparative Examples 1 to 3

Thermoplastic elastomeric compositions were prepared using components in contents set forth in Table 1 below.

TABLE 1

| Component | | Comp. | Comp. | | Comp. | |
|---|---|---|---|---|---|---|
| (parts by weight) | | Example 1 | Example 2 | Example 1 | Example 3 | Example 2 |
| EPDM rubber | | 80 | 80 | 80 | 80 | 80 |
| Polypropylene (PP) | | 61 | 61 | 61 | 31 | 31 |
| Silicon | | — | 5 | 10 | 5 | 10 |
| Poly(styrene-ethylene- | | — | — | 30 | — | 30 |
| butadiene-styrene) (SEBS) | | | | | | |
| Additive | Crosslinking | 0.82 | 0.82 | 0.82 | 0.82 | 0.82 |
| | agent | | | | | |
| | Crosslinking | 0.27 | 0.27 | 0.27 | 0.27 | 0.27 |
| | assistant | | | | | |
| | Surface modifier | 2 | 2 | 2 | 2 | 2 |
| | Lubricant | 0.6 | 0.6 | 0.6 | 0.6 | 0.6 |
| | Antioxidant | 0.4 | 0.4 | 0.4 | 0.4 | 0.4 |
| | Crosslinking | 5 | 5 | 5 | 5 | 5 |
| | accelerator | | | | | |
| | Filler | 29.5 | 29.5 | 29.5 | 29.5 | 29.5 |
| | UV stabilizer | 5 | 5 | 5 | 5 | 5 |
| | Plasticizer | 70 | 70 | 70 | 70 | 70 |

[Components of composition]
(1) EPDM rubber including 58 wt % of polyethylene (PE), and 8.9 wt % of ethylidene norbornene (ENB)

### Test Example

Injected sheets having a thickness of 2 mm were manufactured through an extruder using the thermoplastic elastomeric compositions prepared according to Examples 1 and 2 and Comparative Examples 1 to 3, and specimens for measuring physical properties, i.e., thermoplastic vulcanizates (TPVs), were manufactured.

A detailed method of preparing a specimen, i.e., a thermoplastic vulcanizate (TPV), will be described as below. First, various chemicals were mixed in a supermixer so that the dispersed chemicals were prepared. Thereafter, respective raw materials were put into the extruder, and were mixed in a gap between the screws and the barrel of the extruder. Thereafter, optimized dynamic vulcanization reaction occurred through adjustment of the temperature of the barrel and the combination of the screws. Here, in order to increase dynamic vulcanization reaction efficiency, the particle sizes of respective components were further reduced by adding a kneading section to the combination of the screws (i.e., by increasing shear force). Finally, a TPV product acquired by dynamic vulcanization was extruded and cut simultaneously so as to be pelletized, thereby producing the specimen, i.e., the thermoplastic vulcanizate (TPV).

The physical properties of the manufactured specimens were measured by evaluation methods of respective items. Results of evaluation are set forth in Table 2 below.

[Evaluation Method]
(1) Tensile properties: The tensile properties of the respective specimens were measured at a speed of 500 mm/min using a universal testing machine (UTM) for rubber (DUT-500C) based on ISO 37.
(2) Compression set: The compression sets of the respective specimens were measured for 22 hours in an oven at a temperature of 70° C. after strain of 25% is applied thereto based on ISO 815.
(3) Material damping factor (tan δ): After dynamic strain of 0.2% was applied to the respective specimens and temperature sweep was performed at 10 Hz using an instrument Q850 which is a dynamic mechanical analyzer (DMA) of TA instruments, mean values of damping factors of tan δ of the respective specimens were derived at temperatures of −4 to 4° C.
(4) Friction coefficient and noise acceleration: The coefficients of friction of the respective specimens and the acceleration peaks of the respective specimens during stick slip were measured using an apparatus of Zins-Ziegler instruments GmbH.

TABLE 2

| Evaluation item | | Comp. | Comp. | | Comp. | |
|---|---|---|---|---|---|---|
| (properties) | Unit | Example 1 | Example 2 | Example 1 | Example 3 | Example 2 |
| Hardness | Shore | 80 | 81 | 82 | 71 | 72 |
| | A | | | | | |
| 100% Modulus | MPa | 3.9 | 3.8 | 3.6 | 2.8 | 2.7 |
| Tensile strength | MPa | 8.2 | 7.9 | 8.1 | 7.0 | 7.5 |
| Elongation | % | 500 | 460 | 480 | 510 | 560 |
| Compression | % | 39.34 | 41.31 | 40.77 | 37.83 | 36.33 |
| set | | | | | | |
| 70° C. × 22 hr. | | | | | | |
| Wear evaluation | — | 7025 | 7078 | No wear | 5314 | 8802 |
| under load of | | | | | | |
| 3 kg/10,000 | | | | | | |
| times | | | | | | |

Referring to results set forth in Table 2, the specimen according to Comparative Example 2, which used 5 parts by weight of silicon, per 80 parts by weight of the EPDM rubber, exhibited reduced 100% modulus, tensile strength, elongation, and compression set, but exhibited increased hardness and wear strength, compared to the specimen according to Comparative Example 1, which did not use silicon.

Further, the specimen according to Example 1, which used 10 parts by weight of silicon and 30 parts by weight of SEBS, per 80 parts by weight of the EPDM rubber, exhibited reduced 100% modulus, but exhibited increased hardness, tensile strength, elongation, compression set, and wear strength, compared to the specimen according to Comparative Example 2, which used 5 parts by weight of silicon, per 80 parts by weight of the EPDM rubber.

Moreover, the specimen according to Comparative Example 3, which used 31 parts by weight of polypropylene (PP) and 5 parts by weight of silicon without using SEBS, per 80 parts by weight of the EPDM rubber compared to the specimen according to Example 1, exhibited reduced 100% modulus, tensile strength, and wear strength, but exhibited increased elongation.

In addition, the specimen according to Example 2, which increased the silicon content to parts by weight and further included 30 parts by weight of SEBS, per 80 parts by weight of the EPDM rubber, compared to the specimen according to Comparative Example 3, exhibited reduced 100% modulus, but exhibited increased hardness, tensile strength, elongation, and wear strength.

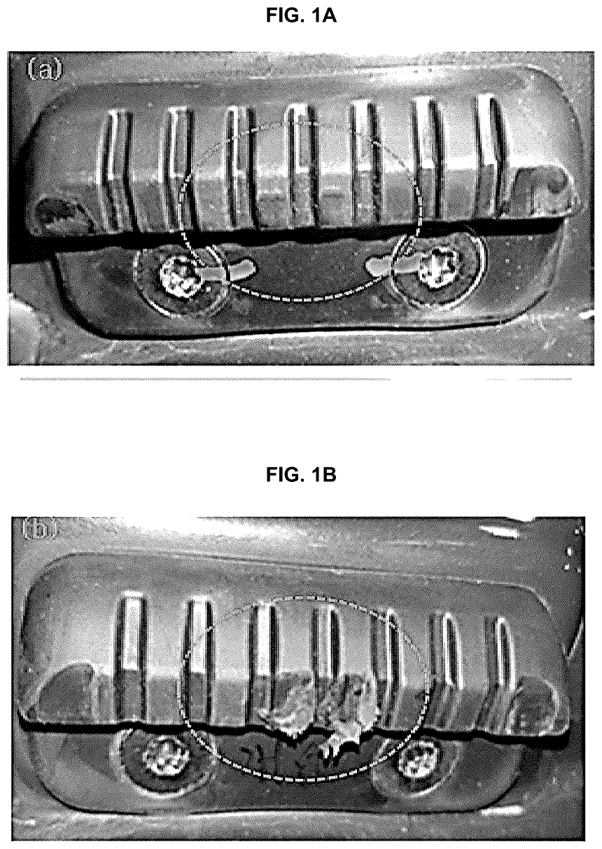

Further, referring to FIGS. 1A and 1B showing results of opening and closing durability evaluation of tail gates of vehicles using thermoplastic elastomeric compositions according to one example and one comparative example, it may be confirmed that the wear performance of the tail gate of a vehicle may be improved by applying a proper amount of SEBS. Here, FIG. 1A shows the result of opening and closing durability evaluation of the tail gate of the vehicle using the thermoplastic elastomeric composition according to Example 1, and FIG. 1B shows the result of opening and closing durability evaluation of the tail gate of the vehicle using the thermoplastic elastomeric composition according to Comparative Example 2.

Friction Noise and Vibration Evaluation

Thereafter, the friction noise and vibration occurred in the specimens manufactured according to Examples 1 and 2 and Comparative Examples 1 to 3 were evaluated. Results of evaluation are set forth in Table 3 below.

In order to confirm reduction in friction noise and vibration based on improvement in material damping, the coefficients of friction of the respective specimens and the acceleration peaks of the respective specimens during stick slip were measured by performing a friction test using the apparatus of Zins-Ziegler instruments GmbH. In the test, after vertical load of 5N was applied to the specimens, i.e., the EPDM/PP thermoplastic elastomeric sheets having a thickness of 2 mm, the specimens were relatively moved at a speed of 3 mm/s.

TABLE 3

| Evaluation item | | Comp. | Comp. | | Comp. | |
|---|---|---|---|---|---|---|
| (properties) | Unit | Example 1 | Example 2 | Example 1 | Example 3 | Example 2 |
| Coefficient of | — | 0.9 | 0.58 | 0.43 | 0.55 | 0.32 |
| static friction | | | | | | |
| Coefficient of | — | 0.69 | 0.64 | 0.60 | 0.62 | 0.54 |
| kinetic friction | | | | | | |
| Maximum | g | 2.41 | 1.28 | 0.95 | 1.26 | 0.83 |
| acceleration | | | | | | |

Depending on the results set forth in Table 3, as the silicon content increases, the coefficient of static friction, the coefficient of kinetic friction and the maximum acceleration decrease.

Further, the specimen according to Example 2, which used 10 parts by weight of silicon and 30 parts by weight of SEBS, per 80 parts by weight of the EPDM rubber, had the lowest coefficients of friction. Further, it may be confirmed that the specimen according Example 2 had the lowest maximum acceleration when stick slip occurs, and thus exhibited the best noise and vibration reduction effects.

Therefore, the thermoplastic elastomeric composition according to various exemplary embodiments of the present invention may be implemented as a specimen which has improved surface energy and compression set while solving reduction in wear strength when the specimen is applied to a vehicle mount, by blending EPDM rubber, polypropylene, silicon, and poly(styrene-ethylene-butadiene-styrene) (SEBS) in appropriate amounts.

A tail gate bumper of a vehicle serves to relieve shock applied to a vehicle body during a process of opening and closing a tail gate of the vehicle. As vehicles are electrified, claims of annoying noise in the tail gates of the vehicles during driving on rough loads are increased, and, in order to solve such a problem, a material which may reduce permanent deformation and have excellent damping properties is required. Further, in order to remove annoying noise, surface modification is required to reduce contact energy.

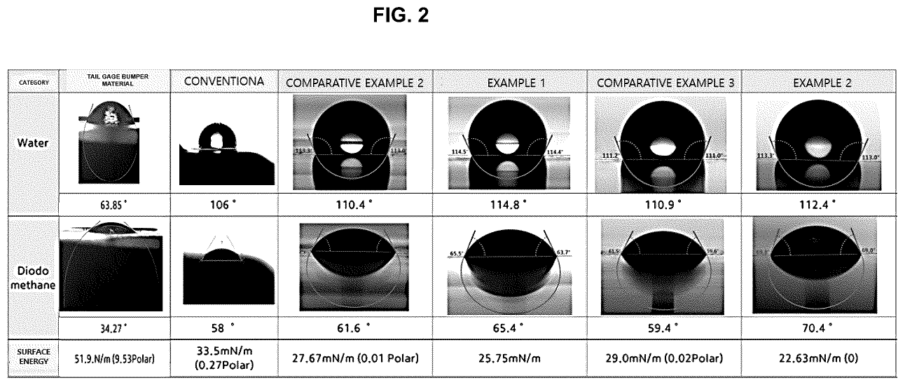

Thus, as shown in FIG. 2, surface contact energy was reduced as the silicon content increases.

Therefore, the thermoplastic elastomeric composition may have surface energy of about 20-35 mN/m, a water (polar) contact angle of about 100-120° with the surface of a tail gate bumper, and a diiodo methane (non-polar) contact angle of about 60-80° with the surface of the tail gate bumper.

That is, the thermoplastic elastomeric composition may adjust the ratio of the EPDM rubber to polypropylene (PP) and the silicon content and may thus modify the surface of an acquired material so as to simultaneously improve the surface energy and compression set of the material, and may additionally include poly(styrene-ethylene-butadiene-styrene) (SEBS) so as to improve reduction in wear strength of a product.

According to various exemplary embodiment of the present disclosure, the thermoplastic elastomeric composition described herein may improve surface energy and compression set while solving reduction in wear strength, by blending EPDM rubber, polypropylene, silicon, and poly(styrene-ethylene-butadiene-styrene) (SEBS).

The thermoplastic elastomeric composition according to various exemplary embodiment of the present invention may adjust the ratio of the EPDM rubber to polypropylene and the silicon content and may thus modify the surface of an acquired material so as to simultaneously improve the surface energy and compression set of the material, and may additionally include poly(styrene-ethylene-butadiene-styrene) (SEBS) so as to improve reduction in wear strength of a product.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A thermoplastic elastomeric composition comprising:
80 parts by weight of ethylene propylene diene monomer (EPDM) rubber;
30 to 70 parts by weight of polypropylene (PP);
2 to 15 parts by weight of silicon; and
20 to 40 parts by weight of poly(styrene-ethylene-butadiene-styrene) (SEBS).

2. The thermoplastic elastomeric composition of claim 1, wherein the EPDM rubber comprises:
an amount of 50 to 70 wt % of polyethylene (PE);
an amount of 5 to 10 wt % of ethylidene norbornene (ENB); and
a balance of polypropylene (PP),
based on the total weight of the EPDM rubber.

3. The thermoplastic elastomeric composition of claim 1, further comprising additives,
wherein the additives comprise a crosslinking agent, a crosslinking assistant, a surface modifier, a lubricant, an antioxidant, a crosslinking accelerator, a filler, a UV stabilizer, and a plasticizer.

4. The thermoplastic elastomeric composition of claim 3, wherein the additives comprise:
an amount of 0.1 to 0.9 parts by weight of the crosslinking agent,
an amount of 0.1 to 0.5 parts by weight of the crosslinking assistant,
an amount of 1 to 3 parts by weight of the surface modifier,
an amount of 1 to 3 parts by weight of the lubricant,
an amount of 0.1 to 0.5 parts by weight of the antioxidant,
an amount of 1 to 3 parts by weight of the crosslinking accelerator,
an amount of 10 to 30 parts by weight of the filler,
an amount of 1 to 5 parts by weight of the UV stabilizer, and
an amount of 60 to 80 parts by weight of the plasticizer, based on 80 parts by weight of the EPDM rubber.

5. The thermoplastic elastomeric composition of claim 1, having surface energy of 20 to 35 mN/m.

6. The thermoplastic elastomeric composition of claim 1, having a water contact angle of 100 to 120° with a surface of a tail gate bumper, and a diiodo methane contact angle of 60 to 80° with the surface of the tail gate bumper.

7. A molded article for vehicle mounts, comprising a thermoplastic elastomeric composition of claim 1.

8. The molded article of claim 7, having tensile strength of 5 to 10 MPa and elongation of 400 to 600%, measured based on ISO 37.

9. The molded article of claim 7, having a compression set of 35 to 45%, measured based on ISO 815.

10. A vehicle comprising a molded article of claim 7.
